(19) United States
(12) Patent Application Publication
(10) Pub. No.: US 2014/0265581 A1
(43) Pub. Date: Sep. 18, 2014

(54) Human Machine Interface for the Local Monitoring and Control of a Containerized Energy Generation and Storage System

(71) Applicants: Robert Bosch GmbH, Stuttgart (DE); Bosch Energy Storage Solutions LLC, Farmington Hills, MI (US)

(72) Inventors: Jasim Ahmed, Mountain View, CA (US); Cordelia Thielitz, Weissach (DE); Kerstin Rittler, Stuttgart (DE); Claire Woo, San Francisco, CA (US)

(73) Assignees: Robert Bosch GmbH, Stuttgart (DE); Bosch Energy Storage Solutions LLC, Farmington Hills, MI (US)

(21) Appl. No.: 14/210,586

(22) Filed: Mar. 14, 2014

Related U.S. Application Data
(60) Provisional application No. 61/786,780, filed on Mar. 15, 2013.

(51) Int. Cl. H02J 7/34

(52) U.S. Cl. CPC H02J 7/34
USPC 307/48

(57) ABSTRACT

A containerized energy storage system including a human-machine interface (HMI). The HMI is located at the site of the containerized energy storage system either in close proximity to the exterior of the system, on an exterior wall of the system, or within a space or compartment formed in the exterior wall of the system which is closable to protect the HMI from the elements but which is accessed exteriorly by a user.

### CROSS-REFERENCE TO RELATED APPLICATIONS

This application claims priority to U.S. Provisional Application Ser. No. 61/786,780 entitled “HUMAN MACHINE INTERFACE FOR THE LOCAL MONITORING AND CONTROL OF A CONTAINERIZED ENERGY GENERATION AND STORAGE SYSTEM” by Ahmed et al., filed Mar. 15, 2013, the disclosure of which is hereby incorporated herein by reference in its entirety.

### TECHNICAL FIELD

This disclosure relates to a containerized energy storage system and more particularly to a human machine interface for a containerized energy storage system.

### BACKGROUND

The present disclosure relates to containerized energy generation and storage systems for stationary applications. A containerized energy storage system consists of electrical storage devices such as batteries, power electronics, controls, thermal management, and other auxiliary components. In one embodiment, the storage system is connected to additional energy generation assets such as wind, solar, hydroelectric, nuclear, geothermal, coal, natural gas or diesel generators and additional energy storage assets such as natural gas storage systems including propane.

Worldwide growth of energy demand, an aging power grid infrastructure, and the increasing share of intermittent renewable resources on the electrical power grid are causing increasing strain on the current energy supply and delivery systems. Stationary storage plays a role in the future electric grid as it enables the time-shifting of energy such that it eliminates the need to always balance the instantaneous power demand and supply. Energy storage serves multiple purposes such as storing energy when generation costs are low and discharging the energy when generation costs are high. Energy storage enhances grid stability through services such as voltage support, frequency regulation, and spinning reserves. This allows a more efficient use of grid assets. Most importantly, storage enables the shifting and smoothing of fluctuating renewable resources so that the usage of energy generated from carbon-free sources is maximized.

The deployment of grid-connected storage systems serves one or more of these purposes. In addition, storage is used in off-grid communities and remote industries in order to minimize the use of fossil fuels and ensure a reliable energy supply. In off-grid applications, the storage system is connected to local generation resources such as wind, solar, diesel, and/or fuel cells.

Due to the complexity of storage systems as they are often connected to multiple other generation assets and due to their distributed nature, there is a need for determining the status of a containerized energy storage system at the site of the system. In addition, there is a need for modifying the operation of the containerized energy storage system at the system site. While a determination of the status of the containerized energy storage system is made remotely from the location of the system, remote access to a containerized energy storage system is often inadequate when system faults occur or when the system requires modification or repair to address new or unanticipated operating procedures.

### BRIEF DESCRIPTION OF DRAWINGS

FIG. 1 is a schematic perspective view of a containerized energy storage system including an HMI.

FIG. 2 is a schematic block diagram of an HMI coupled to a computer system of the containerized energy storage system.

### DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one of ordinary skill in the art to which this disclosure pertains.

The present disclosure relates to the field of transportable containerized power systems that are configured to be transported from one location to another as a single modular unit or as multiple modular units housed in one or more shipping containers. Such power systems are transported from a location of manufacture or from a current location of use to another location. The transportation of a containerized power system is to ensure maximum flexibility so that the containerized system is capable of being transported to a location having the greatest need. For instance in the summer, the system is configured in one embodiment to be located next to a solar plant. The system is also configured in other embodiments where the system is moved to high load areas during an outage event. Whether the containerized power system is being located for a short-period of time (e.g. days or months) or for a long term period of time (e.g. years), local access is provided to monitor and control the containerized power system. In the case of a short term deployment, remote access may be not be set up. Oftentimes, a short-term employment is for an emergency situation that requires special operation that is better monitored locally. Local control is preferred to ensure safe and efficient operation. For long term deployments, local monitoring is useful for maintenance and repair or replacement events.

As described herein, a human machine interface (HMI) is located externally of the containerized power system, either nearby in close proximity or on the exterior of the storage container. The HMI acts as a local communication and control portal for either personnel located at the site of the energy system or for personnel who travel to the site of storage container. Such personnel are collectively called “users” or “operators” in this application. The HMI indicates the current status of the system and allows the user to monitor and control the operation of the storage system. In one embodiment, the HMI exclusively monitors and controls the storage system. In other embodiments, the HMI monitors and controls the containerized power system as well as other energy storage and supply assets connected to the containerized power system.

By incorporating a local HMI into the containerized energy storage system, the containerized energy storage system is improved or optimized. Precise and immediate on-site control and operation of the containerized energy storage system is administered by on-site users.

FIG. 1 depicts one embodiment of a containerized energy storage system 100 having an integrated, externally accessible HMI 102. The containerized storage system 100 comprises a portable container, such as an intermodal container, ISO container, or conex box, that is configured to receive and store energy from one or more energy sources and to output stored energy in one or more forms, e.g., by returning power to a power grid and/or by supplying power to a localized area as a replacement for or in conjunction with a standard power grid. The container may be configured to be transported by ship, rail, truck and/or air. The container may be provided in a variety of different sizes and shapes depending on the application and intended mode of transport. For example, containers typically have a rectangular shape with four side walls, a top, and a bottom. One or more of the sidewalls includes an access opening, such as a door, for accessing the interior of the container. Various features may be provided on the exterior of the container as are known in the art which allow the container to be lifted and transported as needed.

A variety of different systems are incorporated into the container. These systems include energy storage systems 104, energy generating systems 106, power conditioning systems 108, a monitoring system 110, a thermal management system 112, and a control system 114. The storage systems 104 include batteries, fuel cells, or other energy storage devices which are configured to store power generated by or received from one or more power generation devices. Any suitable number and type or types of storage devices may be used. The storage devices can be arranged in a number of different ways within the container. For example, the storage devices can be provided as an array supported on a frame or rack and may be connected together in a variety of different configurations as are known in the art for storing energy. A separate set of storage devices may be provided for each type of energy received by the system 100.

The energy generating systems 106 can include external power generating devices and internal power generating devices. The external power generating devices may generate and/or receive power from sources, such as the national power grid, wind power, solar power, and the like. Devices, such as wind power systems, solar power systems including photovoltaic systems, hydroelectric systems, natural gas systems, diesel generators, biofuel and fossil fuel systems may be deployed to generate energy that is delivered to the system 100. Internal power generating devices may comprise generators, such as diesel powered generators, which can be used to generate power periodically or on an as-needed basis. The diesel generator or generators and/or the power electronics may be housed in separate containers, or may be located externally to the containerized power system.

The power conditioning systems 108 include known electronics such as solid-state electronics for controlling and converting the electric power being generated and received by the system 100. For example, the power conditioning system may include power inverters for changing alternating current (AC) into direct current (DC) or vice versa to charge the storage devices. The power conditioning system may also include power converters for converting or altering the electrical energy into a form suitable for storage. As an example, a power converter may comprise a transformer for changing the voltage of AC power or may comprise a frequency converter for changing the frequency of AC power. Power conditioning systems may include voltage regulators for providing a constant voltage level to other components of the system. Different power conditioning systems may be provided for each type or source of energy utilized by the system.

The storage system may include a power interface which is configured to allow external devices to be connected to the system 100 and to receive power in one form or another, e.g., AC and/or DC current at one or more voltage levels. The power interface may be configured to return power to the power grid and/or to provide power to the local area as an alternative or in addition to the national power grid. Energy stored in storage devices is conditioned by the power conditioning system into a desired format for outputting via the power interface.

The monitoring system 110 includes various monitors and sensors for determining various attributes and characteristics of the generation systems and storage systems and the operability of the other various systems within the container 116. For example, the monitoring system may be configured to monitor and protect the storage devices from overcharge, over-discharge, overcurrent, and/or overheating by detecting a voltage, current, or temperature of the storage devices and monitoring a state of charge of the storage devices, and may function to improve the efficiency of the storage devices through cell balancing. The monitoring system may also be operably connected to external systems and devices 120 for monitoring the state of operation of the external devices.

The system 100 also includes a thermal management system 112 which provides heating and or cooling resources to maintain a desired operating temperature within the container 116. Heat is a byproduct of the generation, storage, and supply of energy. Excessive heat and/or cold within the container can adversely impact system performance. The thermal management system 112 is configured to control the environment within the container so that desired conditions are maintained. The thermal management system may include a variety of different types of components for environmental control, such as ventilation openings, air intakes, fan units, air handling units, dampers, temperature sensors, humidity sensors, pressure sensors, and the like.

A control system controls the operations of the various systems in the container. The control system 68 includes one or more controllers 70, electronic storage or memory 74, and an HMI 78. A controller 70 comprises a processing device, such as a central processing unit (CPU), an application specific integrated circuit (ASIC), a field programmable gate array (FPGA) device, or a microcontroller. The processor is configured to execute programmed instructions that are stored in the memory 74. The memory 22 can be any suitable type of memory, including solid state memory, magnetic memory, or optical memory, just to name a few, and can be implemented in a single device or distributed across multiple devices. The instructions cause the controller to implement various procedures, protocols, and control strategies in operating the components of one or more of the systems.

A separate controller or control system may be provided for some or all of the systems in the container. The separate controllers may be implemented as discrete hardware components, software modules, and/or a combination of hardware and software. Communication between the controllers and various components of the system, such as sensors and environmental controls, is provided over a network. The network 25 can be a wired network, a wireless network, and/or a combination of wired and wireless networks. The controllers and devices which send and receive information and data are provided with the appropriate communication components for communicating over whatever type of network is utilized.

The control system or systems of the container is configured to acquire characteristic data from the various devices of the systems, including data regarding the state of charge from the storage systems, data regarding the status of energy generating devices from the generating systems, data regarding various conditions and parameters monitored by the monitoring system, and data regarding environmental conditions from the thermal management system. The data can include information indicating alarm conditions and warning conditions. The data can also be processed by the control system to determine whether alarms or warning should be generated. The control system or systems may also be configured to implement maintenance procedures on a routine basis or as needed based on the data received from the systems.

The HMI 102 is operably connected to the control system 114 to enable a user or operator to monitor and control the various systems of the container. The HMI includes an output device which is configured to output information, such as the status, operating conditions, and/or control options for the systems within the container. The HMI also includes an input device which is configured to allow a user of the system to input information to the control system, such as requests for information pertaining to one or more systems or devices in the container and instructions to perform certain operations or procedures.

For some applications, the storage system 100 and its external assets 120 are capable of autonomous operation by following a pre-determined operating strategy. In these applications, the HMI 102 serves as a display of the current status and or historical performance of the storage system 100 and the external generation assets 120. For other applications, the storage system 100 requires constant monitoring and occasional commands from an operator, either remotely or locally. In these cases, the HMI 102 serves as the communication portal between the operator and the storage system 100. By placing the HMI 102 on the exterior of the storage system, the local operation and maintenance of the storage system and other generation assets is facilitated on site. Consequently, in the case where system requirements require a fast response to affect the generation and supply of energy, the external HMI 102 provides for substantially immediate access to the system 100. This access becomes particularly important in situation where communication with a remote operator is compromised. In addition, the local access is crucial during maintenance or replacement of parts so that the service technician is always aware of the status of the system.

The HMI 102 may configured to be used as an alternative to or in conjunction with a remote control system for the container system. In one embodiment, the locally placed HMI 102 supplements a remote or wireless monitoring and control interface (not shown) which enables a user to remotely control and monitor the energy storage system via a network, such as the internet. In another embodiment, remote access is restricted and the HMI 102 is the only device used for monitoring and controlling the energy system 100. In still another embodiment, the HMI 102 may be used only during times when remote control system malfunctions or inaccessible.

In one embodiment, the HMI 102 is located externally of the container 116, such as on an exterior surface 117. The HMI 102 is protected from the elements by an awning or roof 118 which is deployed to a predetermined position once the container 116 positioned at the location of use. In another embodiment, the awning 118 is movable by a user and includes a sufficient length such that the awning 118 extends over the HMI 102 when the awning is placed in a first position substantially parallel to the surface 117. The awning 118 is then placed by the user in a second position extending from the surface other than parallel with the surface 117 to enable access to the HMI 102. In other embodiments, the HMI is movable to two or more locations on the exterior of the container to provide optimized access to the HMI. For instance, the exterior is configured to have multiple connectors at different locations such that the HMI is movable to a preferred location.

An entrance 119 is located adjacently to the HMI 102 to provide access to the interior of the container 116. By locating the HMI 102 adjacently to the door 119, procedures performed within the container 116 are readily corrected and verified due to the relative locations of the HMI 102 and the entrance 119. In another embodiment, the HMI 102 is located within an alcove or other chamber extending into the container 116. In still another embodiment, the alcove is covered with a moveable cover which is opened and closed as necessary.

FIG. 2 illustrates a schematic block diagram of the HMI 102 coupled to the controls/computer system 114 of the containerized energy storage system 100. The HMI 102 is connected to various components of the containerized storage system, subsystems, as well as other assets connected to the storage system including those illustrated internally to the container 116 and externally to the container such as the external assets 120. The HMI 102 provides access to software and hardware to monitor all systems and all system components, if necessary or desirable. The HMI 102 displays output parameters that are of interest to the user, receives input commands from the user, and relays the input commands to all system components. The HMI 102 enables a user to control, monitor, assess, or test the storage system 100 or external assets 120 locally without additional equipment or tools. In another embodiment, the HMI 102 displays safety alerts, warnings, alarms, and/or suggested precautions in response to the current status of the system.

In one embodiment, the HMI 102 includes a display 122 and a keyboard 124. The HMI 102 includes the software and hardware components that facilitate the interaction and communication between an operator and the various machines, devices, and systems contained within the container 116 or externally as the external assets 120. The HMI 102 enables the user to provide input commands to the systems, devices, and machines and provides for the display of the output parameters from the systems, devices and machines that are of interest to the user. While the external HMI 102 is hardwired to the controls/computer system 114, in another embodiment the HMI 102 communicates over a wireless connection to the system 114.

In one embodiment, the display may comprise a touchscreen display that enables a user to interact with display elements by touching them on the screen. A touchscreen may be used as an alternative to or in conjunction with a separate keyboard device. Other input devices may also be used, such as a touchpad, a keypad, a mouse, and a joystick. The HMI 102 includes an interface via which determines how a user interacts with the system. The interface may comprise a graphical user interface which allows various objects and elements of the interface to be selected and interacted with by the user in various ways. Alternatively, the interface may comprise a command line interface in which the user types text commands onto a command line using a keyboard (physical or virtual) and the system provides text-based outputs in response to the commands.

As further illustrated in FIG. 2, the display monitors and displays the status of devices, components, or systems. For instance, in one embodiment the display provides past, current, and anticipated values of voltage, current, power, power factor, history, the state of charge of energy storage devices, the state of health of devices, components, and systems, the temperature within the container 116, the operating temperature of devices, components, and systems, and the maintenance status including a maintenance schedule and the completion of scheduled maintenance.

One advantage of a locally installed HMI 102 on a containerized storage system is that it allows the on-site monitoring and control of the storage system. The ability of an operator to assess the status and health of the system locally facilitates the safe operation of the storage system and all of its connected assets. During times when remote or wireless communication is not available or malfunctions, the on-site HMI serves as a backup communication and control portal for the system.

Some storage systems include multiple containers or modules, where each container or module may have their own individual HMI or the entire system shares one HMI. For the latter case, the shared HMI for the entire system may show the status and performance of all of the individual modules, all of the individual systems or components located in the each of the individual modules, some of the modules, or the entire system as a whole. Alternatively, each storage system may include a separate HMI that is capable of accessing each of the container systems so that information for all the container systems can be accessed from the HMI at each container.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A containerized energy storage system comprising:
a portable container configured to be carried by a container transport to a location, the container including a plurality of walls that enclose an interior space;
a storage system provided in the interior space and configured to receive energy from at least one energy source and to store the received energy;
a control system configured to control the operation of the storage system and the monitoring system and to receive information regarding the status of the storage system; and
an human-machine interface (HMI) provided on an exterior wall of the container, the HMI being coupled to the control system and including a display device which displays user-identifiable information pertaining to at least one of a status of the storage system and control options for the storage system, the HMI including an input device which allows a user to input information to the control system.

2. The system of claim 2, wherein the at least one energy source comprises at least one of an electrical power grid, wind, solar, hydroelectric, nuclear, geothermal, coal, natural gas, and diesel generators.

3. The system of claim 2, further comprising:
an energy generating system configured to generate energy for the storage system to store using at least one of wind, solar, hydroelectric, nuclear, geothermal, coal, natural gas, or diesel fuel.

4. The system of claim 2, further comprising:
a monitoring system configured to monitor a status of at least one of the storage system and the energy generating system,
wherein the HMI is configured to receive the status from the monitoring system and to display the status on the display.

5. The system of claim 4, wherein the monitoring system is configured to monitor at least one of a voltage, a current, a power, a power factor, remaining energy, state of charge, and temperature.

6. The system of claim 4, further comprising:
a power interface configured to deliver the energy stored in the storage system to an external receiver.

7. The system of claim 6, wherein the HMI displays historical information pertaining to the storage system, the historical information including at least one of a number of kilowatt-hours (kWh) discharged by the storage system, numbers of cycles performed by the storage devices, and a number of kWhs generated by the generating system within a time period.

8. The system of claim 4, wherein the HMI is configured to allow a user to select one or more procedures to be executed by the control system.

9. The system of claim 8, wherein the procedures include at least one maintenance procedure for the storage system.

10. The system of claim 4, wherein the HMI is configured to generate an alert in response to an alarm condition being detected by the monitoring system.

11. The system of claim 4, wherein the HMI requires password authentication to access the storage system information.

12. The system of claim 4, further comprising:
a diesel generator.

13. The system of claim 4, further comprising:
a remote monitoring system operably connected to the control system.

14. The system of claim 4, wherein the HMI is located within a compartment formed in an exterior wall of the container, the compartment including a cover which is closable over the compartment to protect the HMI from external environmental conditions.
